(19) United States
(12) Patent Application Publication
(10) Pub. No.: US 2010/0066550 A1
(43) Pub. Date: Mar. 18, 2010

(54) VIBRATION-ACTIVATED FLASHLIGHT

(76) Inventor: David MOTTRAM, Derbyshire (GB)

Correspondence Address: OSTROLENK FABER GERB & SOFFEN, 1180 AVENUE OF THE AMERICAS, NEW YORK, NY, 100368403, US

(21) Appl. No.: 12/464,633

(22) Filed: May 12, 2009

Related U.S. Application Data
(60) Provisional application No. 61/052,563, filed on May 12, 2008.

(51) Int. Cl. G08B 21/00; G01H 11/00

(52) U.S. Cl. 340/644; 73/649; 340/691.3

(57) ABSTRACT

A motion or vibration activated flashlight or lamp controlled by a sensing switch to turn it on in response to motion detected and then turn itself off if the detected motion stops or its frequency is below a set frequency. Varying brightness intensities are also disclosed depending on duration of vibration, tilt or motion.

### CROSS REFERENCE TO RELATED APPLICATION

This application claims the benefit of U.S. Provisional Application No. 61/052,563, filed on May 12, 2008.

### FIELD OF THE INVENTION

The present invention relates to the product field of motion, tilt or vibration activated devices, and particularly a battery powered flashlight that responds to such motion.

### BACKGROUND OF THE INVENTION

Flashlights and lights that are battery operated, and related devices that respond to vibration are known. For example, see U.S. Pat. No. 5,400,232 to Wong, U.S. Pat. No. 7,185,996 to Caprio, U.S. Pat. No. 7,156,535 to Deutsch et al., U.S. Pat. No. 6,561,671 to Wang et al., U.S. Pat. No. 5,758,946 to Chen and U.S. Pat. No. 5,184,889 to Vasquez.

In unfamiliar dark places or during a power outage, a lamp or flashlight that automatically turns itself on in response to vibration detected based on the movement of the user would be convenient. For example, in an unfamiliar dark room where the position of the light switches is unknown or would be difficult to find in the dark, a vibration sensing flashlight would turn on without the user tripping or contacting furniture while seeking a light switch. Also, once a conventional lamp is switched off in an unfamiliar dark room, the user has to cautiously move about in the dark.

### SUMMARY OF THE INVENTION

A convenient battery powered flashlight is provided that uses a motion/vibration/tilt detector to switch on the flashlight in response to motion, vibration and/or tilt of the flashlight. When the flashlight is set to an optional automatic mode, the flashlight is turned off until the motion/vibration/tilt detector activates the light source. The light may then stay on for 30 seconds or for some other pre-set time period.

According to an aspect of the present invention, a microprocessor inside the flashlight receives input from the motion/vibration/tilt detector and is operable to set the intensity or brightness of the lamp based on the frequency and/or the detection of vibration or motion, which usually corresponds to the intensity of the movement that triggers the motion/vibration/tilt detector.

One preferred example of a motion/vibration/tilt detector comprises a ball bearing or other freely movable metal piece inside a metal sleeve. The ball bearing moves in the sleeve responsive to motion of the detector and the ball eventually makes contact with electric contacts disposed in the sleeve to close a circuit to a microprocessor programmed to cause a lamp to illuminate. The intensity of the motion of the flashlight could determine the frequency of the pulse cycle inside the motion/vibration/tilt detector.

In another aspect, after sensing a first plurality of vibrations, the microprocessor may be programmed to set the light source at a low intensity and may be programmed to increase the intensity or brightness of the light source if further vibrations are detected within a further predetermined period of time, as the further vibrations usually indicate that the light should be operating.

### BRIEF DESCRIPTION OF THE DRAWINGS

FIG. 1 is a perspective view of an illustration of a flashlight according to an aspect of the present invention.

FIG. 2 is a schematic illustration of a wiring diagram of a flashlight according to an aspect of the present invention.

FIG. 3 is a flowchart illustrating an operation sequence of a flashlight controlled by a microprocessor according to an aspect of the present invention.

### DESCRIPTION OF A PREFERRED EMBODIMENT

While the product embodying this invention is referred to herein as a flashlight, other types of lighting, such as lamps, including desk lamps, floor lamps, personal illumination devices or the like are also contemplated within the scope of this invention, that is any lamp or light that should be controlled by a motion/vibration/tilt detector.

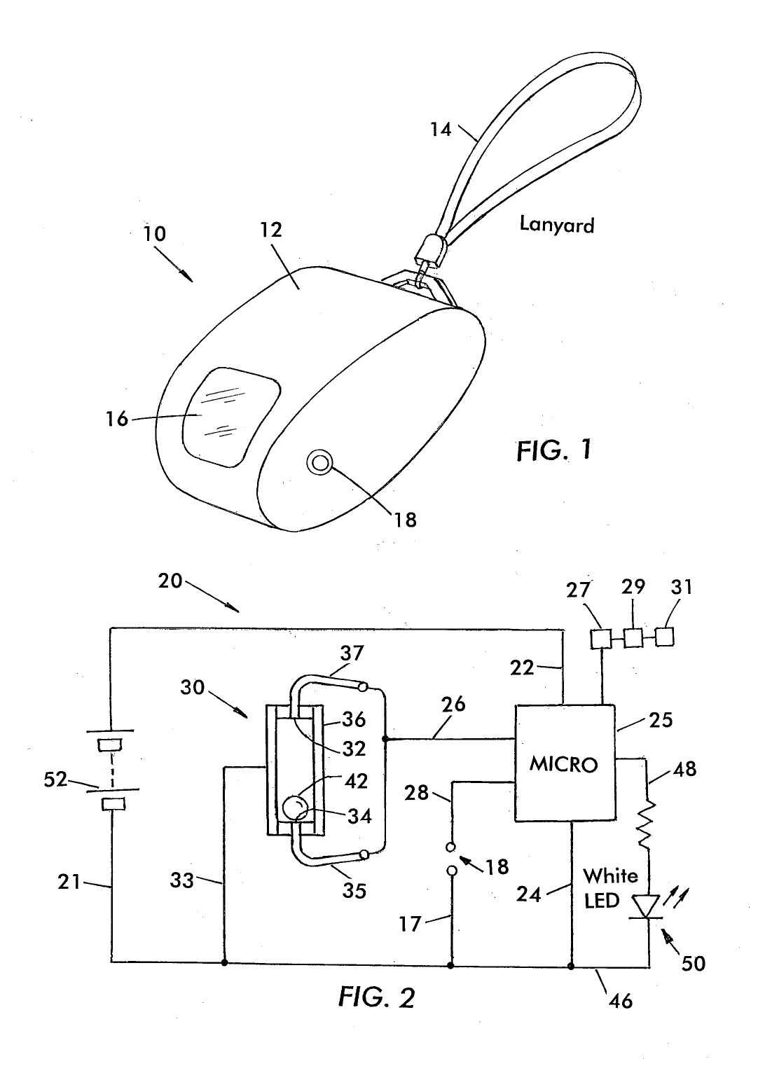

An embodiment of a flashlight according to the invention 10 is shown in FIG. 1. Its exterior housing 12 is configured to be of a size and shape convenient for a person to wear, for example, around a wrist or around a neck, e.g., by a lanyard 14. However, it will be understood that other types of shapes and sizes for the flashlight are also contemplated, for example, polygons, ovular shapes and irregular ovular shapes, such as pebble shapes or egg shapes, in which one end is substantially flat so that it may be placed conveniently on a flat surface and the area near the flat end bulges out slightly more or is slightly bigger than the top area so that the flashlight is stable when placed on a flat surface. There is a light output window or lens in the housing 12. An on-off switch 18 for operator control of the light is also accessible externally on the housing. This enables the light to be turned on and off without responding to motion, vibration or tilt.

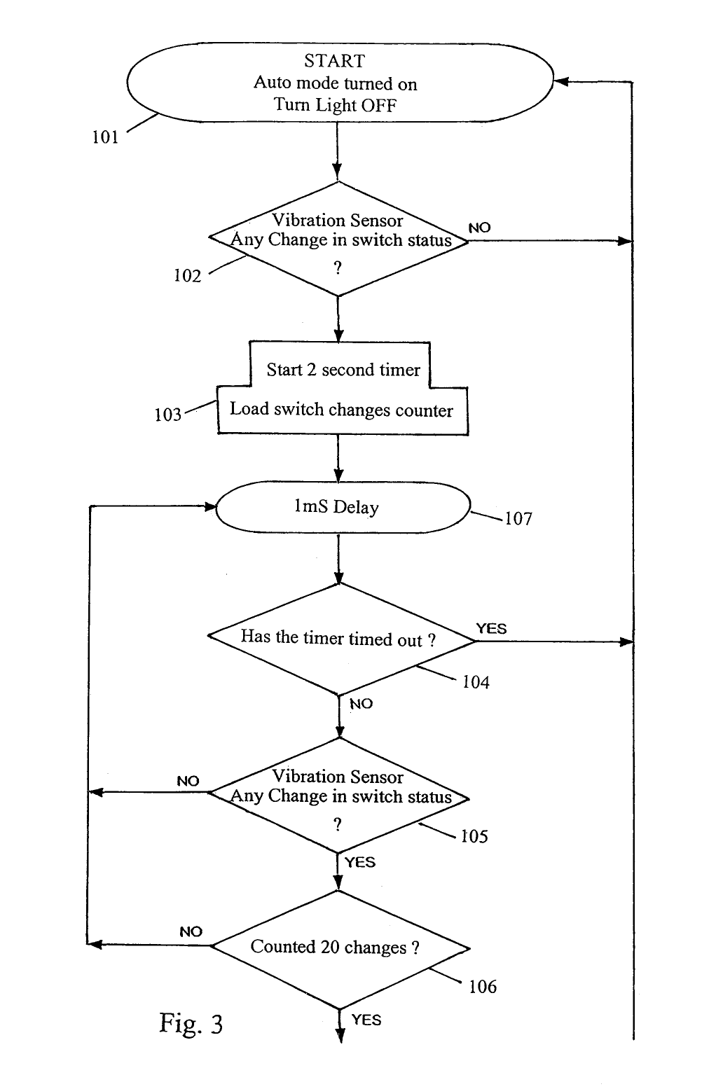

FIG. 2 is a non-limiting example of a circuit that might be present in the flashlight 10. FIG. 2 shows schematically a motion/vibration/tilt detector that includes switches that provide signals to a programmed microprocessor that controls a light source. An example of a motion/vibration/tilt detector is available from SignalQuest.

Referring to the circuit 20 in FIG. 2, which is an example of a circuit that may be used in the flashlight 10, the circuit 20 leads to the microprocessor 25 through the leads 22 and 24. In a first manual mode of operation, these connections will energize the microprocessor when the switch 18 has been closed by the operator and the microprocessor has been programmed to initiate continuous operation of the light source 50. Another input to the microprocessor for initiating operation of the light source 50 is from the lead 26, which leads from a motion/vibration/tilt switch 30. In another, automatic mode of operation, when a contact in the switch 30 is closed, a signal is sent to the microprocessor through the lead 26 and the microprocessor is programmed to then perform its below described steps with respect to illuminating the light source. The switches 18 and 30 are connected to the microprocessor 25 in parallel with each other, whereby connection by one or the other switch causes the programmed microprocessor to act as programmed to illuminate the light source.

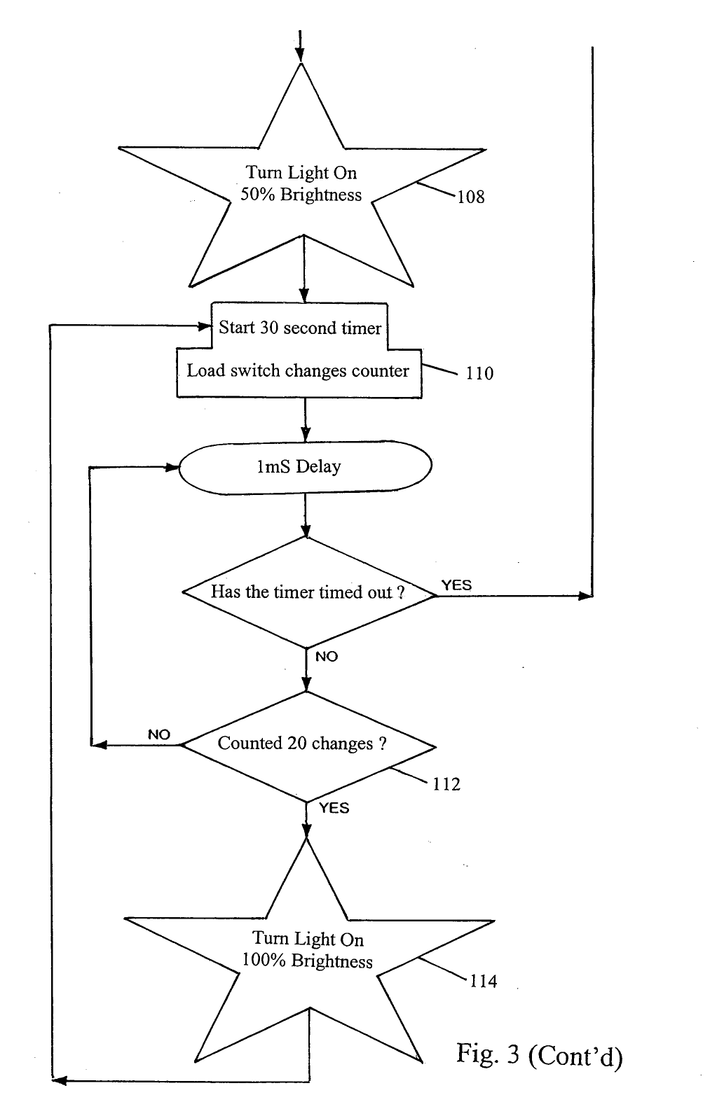

A motion/vibration/tilt switch is a known commodity and there are several types. The switch 30, shown schematically in FIG. 2, includes a conductive metal tube 32 which contains spaced apart, opposing electric contacts 34 and 36. Contact 34 is connected by leads 35, 26 to the microprocessor. Contact 36 is connected by leads 37, 26 to the microprocessor. A conductive metal bearing ball 42 in the tube 32 is slightly smaller in diameter than the diameter of the tube 32 so that the ball can move freely through the tube. The metal ball makes contact between either contact 34 or 36 and the tube 32 or the ball is off both contacts 34 and 36. As the ball 42 contacts either of the electric contacts 34 or 36 or contacts none of them, an electric signal is or is not sent to the microprocessor, and the microprocessor is programmed to count a time period between successive contacts between the ball and one of the contacts to selectively activate the microprocessor to activate a light source 50 as described in connection with the flow diagram, FIG. 3.

Through the leads 24, 46, 48, the microprocessor 25 is connected with the light source 50, and the microprocessor is programmed to selectively electrify the light source via the connected leads, or not, according to the programming.

A power source for the entire circuit 20 may be a battery 52, for example a three volt battery, which is connected into the circuit 21. Through lead 33 electricity is connected to the metal tube 32. Through lead 17, switch 18 and lead 28 electricity is connected to the microprocessor 25. Through leads 24, 46, and 48 electricity is connected to the LED light source.

In the illustrative embodiment in FIG. 2, the light source 50 is a light emitting diode (LED) and particularly a white LED light source because the long life and relatively low power usage of the LED has advantages, particularly for a flashlight powered by batteries. However, other types of light sources may also be used, including incandescent light bulbs, fluorescent lamps, halogen lamps or combinations of the foregoing. Also, while a single light source is illustrated, more than one such light source may be deployed. Further, while the light source may emit white light, other colors of light may be emitted and the microprocessor may control the light source to pulse or flash, depending on the needs of the application. The battery 52 may be a rechargeable battery, or the flashlight may include a removable or non-removable plug-in charger.

An operation of a flashlight according to the present invention in its automatic mode is described with reference to FIG. 3. Via circuit 20, the flashlight may be switched to on, off or auto mode according to the need of a user.

In step 101, the auto mode is turned on, that is the motion/vibration/tilt switch is turned on. When it is switched to auto mode in step 101, the microprocessor 25 will await a signal from a switch 30 controlled by a motion/vibration/tilt detector or sensor 32, 34, 36, and is programmed to react when one or more such signals is received in step 102. When the motion/vibration/tilt detector provides a signal indicating that a vibration or motion has been sensed, the microprocessor 25 starts a timer 27, for example, a two-second timer, in step 103, and then awaits further signals from the motion/vibration/tilt detector. A greater or smaller amount of time may be provided for that timer 27. If no further signal is provided by the motion/vibration/tilt detector within the set time period measured by the timer 27, in step 104, then the microprocessor is programmed so that the light source 50 remains off If an additional signal from detector 32, 35, 36 is provided to the microprocessor within the measured time period, at step 105, then a load counter at 29 is incremented to indicate the detection of additional movement and the microprocessor waits for additional signals from the motion/vibration/tilt detector. If a number of such signals are received within the measured time period of the timer, at step 106, for example, within two seconds for the purposes of this embodiment, then the light source 50 is activated by the microprocessor 25 to a predetermined level of brightness, for example, 50 percent of the maximum brightness, at step 108. The timer 27 and a timer in Step 107 may be necessary in order to filter out trivial or insignificant vibrations detected by the motion/vibration/tilt detector or to filter out signals that are mere artifacts of previous vibrations.

A delay, such as a one millisecond delay, at step 107, or some other predetermined period of time delay, may be imposed by the microprocessor between receipt of the signal from the motion/vibration/tilt detector and a further signal receipt time to make sure that each signal corresponds to a real world movement or significant distinct movement rather than further motion of the bearing ball 42 within the metal sleeve 32 of the motion/vibration/tilt detector unrelated to switch motion or due to other insignificant vibrations.

Once the light source 50 is thus automatically activated, a second timer 31, such as a 30-second timer, may be switched on, at step 110, to control the period for which the light is allowed by the microprocessor to be on based on the automatic detection process. Also, if within the time allotted by the second timer 31, at step 112, additional significant movement is detected at switch 30, the light source may be switched to a higher level of brightness, such as to full brightness, in step 114. Also, while operations for two intensity settings are illustrated in FIG. 3, additional increments, such as three or more levels of illumination, may also be provided.

A light or flashlight as disclosed above may be conveniently used during travel, for example, it may be placed on a night stand and could turn on automatically in response to movements of the flashlight that cause motion, vibration or tilt of the detector 30, and could later turn off automatically again under appropriate programming of the microprocessor. Potential uses are unlimited.

In addition, the flashlight may be useful to alert the user in case an unexpected or unwanted person or animal approaches the user and vibrates or tilts the detector.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A motion/vibration/tilt operable apparatus comprising:
a light source selectively operable between an on illuminated and an off condition,
a microprocessor programmed and controllable for selectively turning the light source on and off;
a first connection from a power source to the microprocessor, the first connection including a first switch that may be selectively placed in the closed condition and the microprocessor being operable when the first switch is in the closed condition to turn the light source on;
a second motion/vibration/tilt sensing switch also connected from the power source to the microprocessor and connected to the microprocessor in parallel with the first switch; the motion/vibration/tilt sensing switch including contacts which change between open and closed conditions as the switch and the apparatus in which the switch is located are moved, vibrated or tilted;
a counter connected with the microprocessor for counting the frequency of the opening and closing of contacts at the motion/vibration/tilt switch, and a timer for the counter operation; and
upon a sufficient number of contact openings or closings being counted in a time period, the microprocessor being programmed to cause illumination of the light source in a first mode.

2. The apparatus of claim 1, further comprising the timer being operable to time a second time period and the counter counting the number of opening and closings of the contacts in the motion/vibration/tilt switch during the second time period, and upon that count of openings and closings exceeding a selected frequency during the second time period, the microprocessor being programmed to operate the light source in a second illumination mode.

3. The apparatus of claim 2, wherein in the second illumination mode, the light source is of brighter illumination than in the first illumination mode.

4. The apparatus of claim 1, further comprising a battery connected in circuit with the first and second switches to provide the power supply.

5. A method for illuminating a light source which is activated by motion, vibration or tilting of a motion/vibration/tilt sensing switch, the method comprising
positioning the motion/vibration/tilt sensing electric switch at a location where the presence of motion, vibration or tilt is to be sensed;
connecting a microprocessor with the motion/vibration/tilt switch for sensing the opening and closing of the switch, counting a first time period, programming the microprocessor to detect opening and closing of the switch during the first time period and to determine the frequency of opening and closing of the switch during the first time period, and
if the frequency of opening and closing of the switch during the first time period exceeds a first preset frequency, programming the microprocessor to illuminate the light source as an indication of that frequency of opening and closing of the switch.

6. The method of claim 5, further comprising
after the first time period and if the microprocessor has illuminated the light source after the first period, counting a second time period, detecting continued closing and opening of the switch during the second time period, and if the frequency of opening and closing of the switch during the second time period after the first time period exceeds a second preset frequency, programming the microprocessor to change the intensity of the illumination by the light source.

7. The method of claim 5, wherein if the frequency of the opening and closing of the switch in the first measured time period does not exceed the first preset frequency, programming the microprocessor to maintain the light source unilluminated.

8. A method for illuminating a light source which is activated by motion, vibration or tilting of a sensing switch, the method comprising:
positioning a motion/vibration/tilt sensing switch at a location where motion, vibration or tilt is to be sensed;
sensing and counting the opening and closing of the switch, counting a first time period, from the count of the opening and closing of the switch during the first time period, determining the frequency of the opening and closing of the switch during the first time period;
if the frequency of the opening and closing of the switch during the first time period exceeds a first preset frequency, illuminating the light source as an indication of that frequency of opening and closing of the switch.

9. The method of claim 8, further comprising
after the first time period, counting a second time period and sensing and counting opening and closing of the switch during the second time period;
if the frequency of the opening and closing of the switch during the second time period exceeds a second preset frequency, change the intensity of the illumination of the light source.

10. The method of claim 8, wherein if the frequency of the opening and closing of the switch in the first time period does not exceed the first preset frequency, the light source remains unilluminated.

11. The method of claim 10, further comprising:
alternatively switching on the light source without consideration of the frequency of opening and closing of the switch.
